(19) United States
(12) Patent Application Publication
(10) Pub. No.: US 2015/0310365 A1
(43) Pub. Date: Oct. 29, 2015

(54) SYSTEM AND METHOD FOR VIDEO-BASED DETECTION OF GOODS RECEIVED EVENT IN A VEHICULAR DRIVE-THRU

(71) Applicant: Xerox Corporation, Norwalk, CT (US)

(72) Inventors: Qun Li, Webster, NY (US); Edgar A. Bernal, Webster, NY (US); Matthew A. Shreve, Tampa, FL (US)

(73) Assignee: Xerox Corporation, Norwalk, CT (US)

(21) Appl. No.: 14/289,683

(22) Filed: May 29, 2014

Related U.S. Application Data
(60) Provisional application No. 61/984,476, filed on Apr. 25, 2014.

(51) Int. Cl. G06Q 10/06; G06K 9/62; G06K 9/46; G06K 9/00

(52) U.S. Cl. CPC G06Q 10/0639; G06Q 10/063; G06K 9/00798; G06K 9/6267; G06K 9/4604

(57) ABSTRACT

A system and method for detection of a goods-received event includes acquiring images of a retail location including a vehicular drive-thru, determining a region of interest within the images, the region of interest including at least a portion of a region in which goods are delivered to a customer, and analyzing the images using at least one computer vision technique to determine when goods are received by a customer. The analyzing includes identifying at least one item belonging to a class of items, the at least one item's presence in the region of interest being indicative of a goods-received event.

### CROSS REFERENCE TO RELATED PATENTS AND APPLICATIONS

This application claims priority to and the benefit of the filing date of U.S. Provisional Patent Application Ser. No. 61/984,476, filed Apr. 25, 2014, which application is hereby incorporated by reference.

### BACKGROUND

Advances and increased availability of surveillance technology over the past few decades have made it increasingly common to capture and store video footage of retail settings for the protection of companies, as well as for the security and protection of employees and customers. This data has also been of interest to retail markets for its potential for data-mining and estimating consumer behavior and experience to aid both real-time decision making and historical analysis. For some large companies, slight improvements in efficiency or customer experience can have a large financial impact.

Several efforts have been made at developing retail-setting applications for surveillance video beyond well-known security and safety applications. For example, one such application counts detected people and records the count according to the direction of movement of the people. In other applications, vision equipment is used to monitor queues, and/or groups of people within queues. Still other applications attempt to monitor various behaviors within a reception setting.

One industry that is particularly heavily data-driven is fast food restaurants. Accordingly, fast food companies and/or other restaurant businesses tend to have a strong interest in numerous customer and/or store qualities and metrics that affect customer experience, such as dining area cleanliness, table usage, queue lengths, experience time in-store and drive-thru, specific order timing, order accuracy, and customer response.

Modern retail processes are becoming heavily data-driven, and retailers therefore have a strong interest in numerous customer and store metrics such as queue lengths, experience time in-store and/or drive-thru, specific order timing, order accuracy, and customer response. Event timing is currently established with some manual entry (sale) or “bump bar.” Bump bars are commonly being cheated by employees that “bump early.” That is, employees recognize that one measure of their performance is the speed with which they fulfill orders and, therefore, that they have an incentive to indicate that they have completed the sale as soon as possible. This leads some employees to “bump early” before the sale is completed. The duration of many other events may not be estimated at all.

Delay in the delivering of the goods to the customer or order inaccuracy may lead to customer dissatisfaction, slowed performance, as well as potential losses in repeat business. There is currently no automated solution to the detection of “goods received” events, since current solutions for operations analytics involve manual annotation often carried out by employees.

Previous work has primarily been directed to detecting in-store events for acquiring timing statistics. For example, a method to identify the “leader” in a group at a queue through recognition of payment has been proposed. Another approach measures the experience time of customers that are not strictly constrained to a line-up queue. Still another approach includes a method to identify specific payment gestures.

### INCORPORATION BY REFERENCE

The following references, the disclosures of which are incorporated by reference herein in their entireties are mentioned:

U.S. application Ser. No. 13/964,652, filed Aug. 12, 2013, by Shreve et al., entitled “Heuristic-Based Approach for Automatic Payment Gesture Classification and Detection”;

U.S. application Ser. No. 13/933,194, filed Jul. 2, 2013, by Mongeon et al., and entitled “Queue Group Leader Identification”;

U.S. application Ser. No. 13/973,330, filed Aug. 22, 2013, by Bernal et al., and entitled “System and Method for Object Tracking and Timing Across Multiple Camera Views”;

U.S. patent application Ser. No. 14/195,036, filed Mar. 3, 2014, by Li et al., and entitled “Method and Apparatus for Processing Image of Scene of Interest”;

U.S. patent application Ser. No. 14/089,887, filed Nov. 26, 2013, by Bernal et al., and entitled “Method and System for Video-Based Vehicle Tracking Adaptable to Traffic Conditions”;

U.S. patent application Ser. No. 14/078,765, filed Nov. 13, 2013, by Bernal et al., and entitled “System and Method for Using Apparent Size and Orientation of an Object to improve Video-Based Tracking in Regularized Environments”;

U.S. patent application Ser. No. 14/068,503, filed Oct. 31, 2013, by Bulan et al., and entitled “Bus Lane Infraction Detection Method and System”;

U.S. patent application Ser. No. 14/050,041, filed Oct. 9, 2013, by Bernal et al., and entitled “Video Based Method and System for Automated Side-by-Side Traffic Load Balancing”;

U.S. patent application Ser. No. 14/017,360, filed Sep. 4, 2013, by Bernal et al. and entitled “Robust and Computationally Efficient Video-Based Object Tracking in Regularized Motion Environments”;

U.S. Patent Application Publication No. 2014/0063263, published Mar. 6, 2014, by Bernal et al. and entitled “System and Method for Object Tracking and Timing Across Multiple Camera Views”;

U.S. Patent Application Publication No. 2013/0106595, published May 2, 2013, by Loce et al., and entitled “Vehicle Reverse Detection Method and System via Video Acquisition and Processing”;

U.S. Patent Application Publication No. 2013/0076913, published Mar. 28, 2013, by Xu et al., and entitled “System and Method for Object Identification and Tracking”;

U.S. Patent Application Publication No. 2013/0058523, published Mar. 7, 2013, by Wu et al., and entitled “Unsupervised Parameter Settings for Object Tracking Algorithms”;

U.S. Patent Application Publication No. 2009/0002489, published Jan. 1, 2009, by Yang et al., and entitled “Efficient Tracking Multiple Objects Through Occlusion”;

Azari, M.; Seyfi, A.; Rezaie, A. H., “Real Time Multiple Object Tracking and Occlusion Reasoning Using Adaptive Kalman Filters”, Machine Vision and Image Processing (MVIP), 2011, 7th Iranian, pages 1-5, Nov. 16-17, 2011;

### BRIEF DESCRIPTION

In accordance with one aspect, a method for detection of a goods-received event comprises acquiring images of a vehicular drive-thru associated with a business, determining a first region of interest within the images, the region of interest including at least a portion of a region in which goods are delivered to a customer, and analyzing the images using at least one computer vision technique to determine when goods are received by a customer. The analyzing includes identifying at least one item belonging to a class of items, the at least one item's presence in the region of interest being indicative of a goods-received event.

The method can further include, prior to the analyzing, detecting motion within the region of interest, and analyzing the images only after motion is detected. The method can also include, prior to the analyzing, detecting a vehicle within a second region of interest. The analyzing can be performed, for example, only when a vehicle is detected in the second region of interest. The method can include issuing a goods-received alert when goods are received by the customer. The alert can include at least one of a real-time notification to a store manager or employee, an update to a database entry, an update to a performance statistic, or a real-time visual notification.

The analyzing can include using an image-based classifier to detect at least one specific item within the region of interest. An output of the image-based classifier can be compared to a customer order list to verify order accuracy. An output of the image-based classifier and timing information are used to analyze a customer experience time relative to order type. An output of the image-based classifier can also be used to analyze general statistics including relationships between order type and time of day, weather conditions, time of year, vehicle type, vehicle occupancy, etc. The using an image-based classifier can include using at least one of a neural network, a support vector machine (SVM), a decision tree, a decision tree ensemble, or a clustering method. The analyzing includes training multiple two-class classifiers for each class of items.

In accordance with another aspect, a system for video-based detection of a goods received event comprises a device for monitoring customers including a memory in communication with a processor configured to acquire images of a vehicular drive-thru associated with a business, determine a first region of interest within the images, the region of interest including at least a portion of a region in which goods are delivered to a customer, and analyze the images using at least one computer vision technique to determine when goods are received by a customer, the analyzing includes identifying at least one item belonging to a class of items, the at least one item's presence in the region of interest being indicative of a goods-received event.

### BRIEF DESCRIPTION OF THE DRAWINGS

FIG. 1 is a block diagram of a goods received event determination system according to an exemplary embodiment of the present disclosure.

FIG. 2 shows a sample video frame captured by the video acquisition module in accordance with one exemplary embodiment of present disclosure.

FIG. 3 shows a sample ROI labeled manually in accordance with one embodiment of the present disclosure.

FIG. 4a shows a sample video frame acquired for analysis in accordance with one embodiment of the present disclosure.

FIG. 4b shows a detected foreground mask for goods exchange ROI from the sample video frame of FIG. 4a.

FIG. 4c shows a detected foreground mask for the vehicle detection module for a second ROI from the sample video frame of FIG. 4a.

FIG. 5 is a flowchart of a goods received event detection process according to an exemplary embodiment of this disclosure.

FIG. 6 A-D show performance comparison of four different types of classifiers.

### DETAILED DESCRIPTION

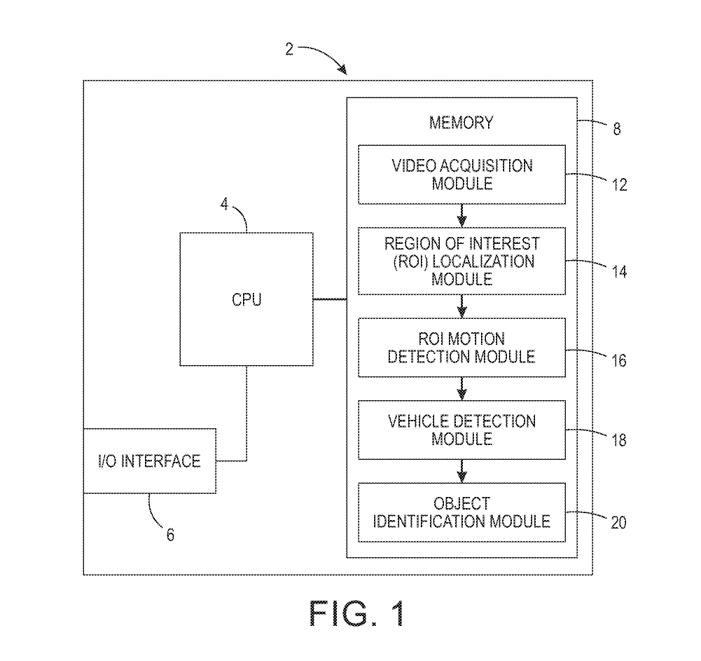

With reference to FIG. 1, an exemplary system 2 in accordance with the present disclosure is illustrated and identified generally by reference numeral 2. The system 2 includes a CPU 4 that is adapted for controlling an analysis of video data received by the system 2, an I/O interface 6, such as a network interface for communicating with external devices. The interface 6 may include, for example, a modem, a router, a cable, and/or Ethernet port, etc. The system 2 includes a memory 8. The memory 8 may represent any type of tangible computer readable medium such as random access memory (RAM), read only memory (ROM), magnetic disk or tape, optical disk, flash memory, or holographic memory. In one embodiment, the memory 8 comprises a combination of random access memory and read only memory. The CPU 4 can be variously embodied, such as by a single-core processor, a dual-core processor (or more generally by a multiple-core processor), a digital processor and cooperating math coprocessor, a digital controller, or the like. The CPU, in addition to controlling the operation of the system 2, executes instructions stored in memory 8 for performing the parts of the system and method outlined in FIG. 1. In some embodiments, the CPU 4 and memory 8 may be combined in a single chip. The system 2 includes one or more of the following modules:

(1) a video acquisition module 12 which acquires video from the drive-thru window(s) of interest;

(2) a first region of interest (ROI) localization module 14 which determines the location, usually fixed, of the image area where the exchange of goods occurs in the acquired video;

(3) an ROI motion detection module 16 which detects motion in the localized ROI;

(4) a vehicle detection module 18 which detects the presence of a vehicle in a second ROI adjacent to, partially overlapping with, or the same as the first ROI; and

(5) an object identification module 20 which determines whether objects in the first ROI correspond to objects associated with a ‘goods received’ event. Optionally, this module can perform fine-grained classification relative to simple binary event detection (e.g., to identify objects as belonging to ‘bag’, ‘coffee cup’, and ‘soft drink cup’ categories).

The details of each module are set forth herein. It will be appreciated that the system 10 can include one or more processors for performing various tasks related to the one or more modules, and that the modules can be stored in a non-transitive computer readable medium for access by the one or more processors.

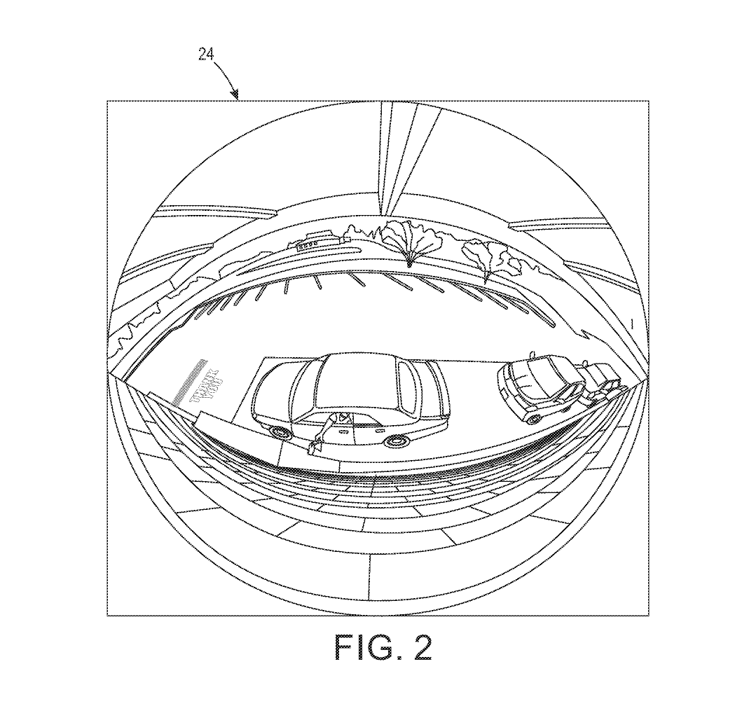

The video acquisition module 12 includes at least one, but possibly multiple video cameras that acquire video of the region of interest, including the drive-thru window being monitored and its surroundings. The type of cameras could be any of a variety of surveillance cameras suitable for viewing the region of interest and operating at frame rates sufficient to view a pickup gesture of interest, such as common RGB cameras that may also have a “night mode”, and operate at 30 frames/sec, for example. FIG. 2 shows a sample video frame 24 acquired with a camera set up to monitor a drive-thru window of a restaurant. The cameras can include near infrared (NIR) capabilities at the low-end portion of a near-infrared spectrum (700 nm-1000 nm). No specific requirements are needed regarding spatial or temporal resolutions. The image source, in one embodiment, can include a surveillance camera with a video graphics array size that is about 1280 pixels wide and 720 pixels tall with a frame rate of thirty (30) or more frames per second. The video acquisition module can include a camera sensitive to visible light or having specific spectral sensitivities, a network of such cameras, a line-scan camera, a computer, a hard drive, or other image sensing and storage devices. In another embodiment, the video acquisition module 12 may acquire input from any suitable source, such as a workstation, a database, a memory storage device, such as a disk, or the like. The video acquisition module 12 is in communication with the CPU 4, and memory 8.

In the case where more than one camera is needed to cover the area of interest, the video acquisition module is capable of calibrating multiple cameras to interpret the data. Because the acquired video frame(s) is a projection of a three-dimensional space onto a two-dimensional plane, ambiguities can arise when the subjects are represented in the pixel domain (i.e., pixel coordinates). These ambiguities are introduced by perspective projection, which is intrinsic to the video data. In the embodiments where video data is acquired from more than one camera (each associated with its own coordinate system), apparent discontinuities in motion patterns can exist when a subject moves between the different coordinate systems. These discontinuities make it more difficult to interpret the data. In one embodiment, these ambiguities can be resolved by performing a geometric transformation by converting the pixel coordinates to real-world coordinates. Particularly in a case where multiple cameras cover the entire area of interest, the coordinate systems of each individual camera are mapped to a single, common coordinate system.

Any existing camera calibration process can be used to perform the estimated geometric transformation. One approach is described in the disclosure of co-pending and commonly assigned U.S. application Ser. No. 13/868,267, entitled “Traffic Camera Calibration Update Utilizing Scene Analysis,” filed Apr. 13, 2013 by, Wencheng Wu, et al., the content of which is totally incorporated herein by reference.

While calibrating a camera can require knowledge of the intrinsic parameters of the camera, the calibration required herein needs not be exhaustive to eliminate ambiguities in the tracking information. For example, a magnification parameter may not need to be estimated.

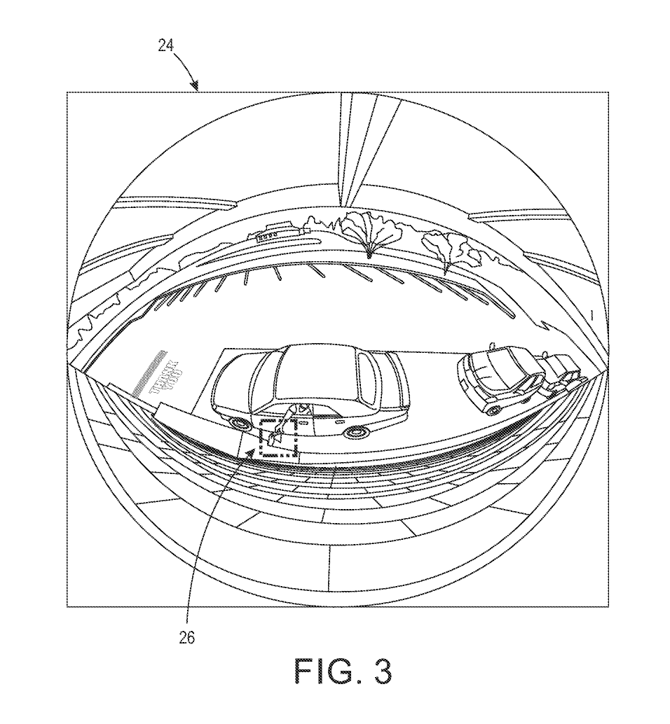

The region of interest (ROI) localization module 14 determines the location, usually fixed, of the image area where the exchange of goods occurs in the acquired video. This module usually involves manual intervention on the part of the operator performing the camera installation or setup. Since ROI localization is performed very infrequently (upon camera setup or when cameras get moved around), manual intervention is acceptable. Alternatively, automatic or semi-automatic approaches can be utilized to localize the ROI. For example, statistics of the occurrence of motion or detection of hands (e.g., from detection of skin color areas in motion) can be used to localize the ROI. FIG. 3 shows the video frame 24 from FIG. 2 with the located ROI highlighted by a dashed line box 26.

The ROI motion detection module 16 detects motion in the localized ROI. Motion detection can be performed via various methods including temporal frame differencing and background estimation/foreground detection techniques, or other computer vision techniques such as optical flow. When motion or a foreground object is detected in the ROI, this module triggers a signal to the object identification module 20 to apply an object detector to the ROI. This operation is optional because the object detector can simply operate on every video frame regardless of motion having been detected in the ROI with similar results. That said, applying the object detector only on frames where motion is detected improves the computational efficiency of the method. In one embodiment, a background model of the ROI is maintained via statistical models such as a Gaussian Mixture Model for background estimation. This background estimation technique uses pixel-wise Gaussian mixture models to statistically model the historical behavior of the pixel values in the ROI. As new video frames come in, a fit test between pixel values in the ROI and the background models is performed in order to accomplish foreground detection. Other types of statistical models can be used, including running averages, medians, other statistics, and parametric and non-parametric models such as kernel-based models.

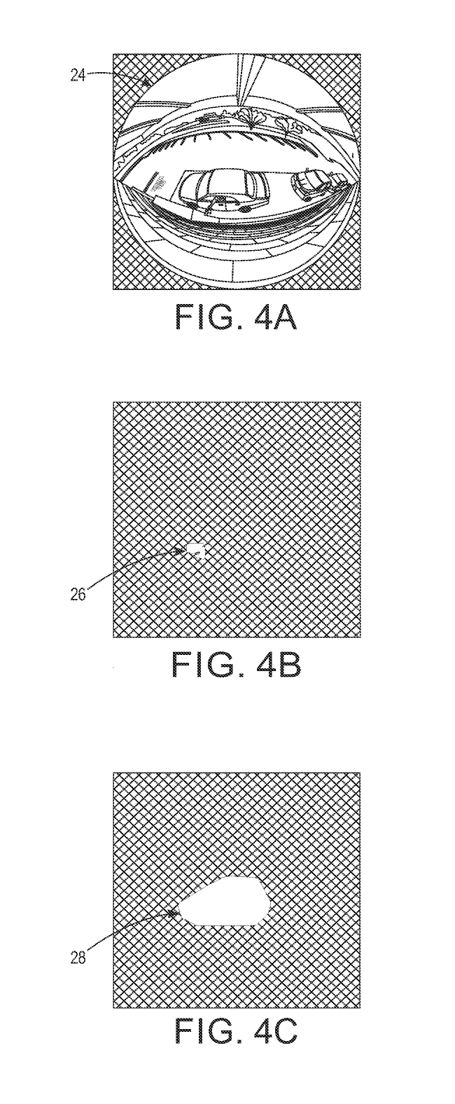

The vehicle detection module 18 detects the presence of a vehicle at the order pickup point. Similar to the ROI motion detection, this module may operate based on motion or foreground detection techniques operating on a second ROI adjacent to, partially overlapping with, or the same as the ROI previously defined by the ROI localization module. Alternatively, vision-based vehicle detectors can be used to detect the presence of a vehicle at the pickup point. When the presence of a vehicle is detected, this module triggers a signal to the object identification module 20 to apply an object detector to the first ROI. Like the previous module, this module is also optional because the object detector can operate on every frame regardless of a vehicle having been detected at the pickup point. Additionally, the outputs from the ROI motion detection 16 and the vehicle detection module 18 can be combined when both of them are present. FIGS. 4a-4(c) illustrate the sample video frame 24, a binary mask 26 resulting from the output of the ROI motion detection module and the binary mask 28 resulting from the output the vehicle detection module, respectively.

In one embodiment, vehicle detection is performed by detecting an initial instance of a subject entering the second ROI followed by subsequent detections or vehicle tracking. In one embodiment, a background estimation method that allows for foreground detection to be performed is used. According to this approach, a pixel-wise statistical model of historical pixel behavior is constructed for a predetermined detection area where subjects are expected to enter the field(s) of view of the camera(s), for instance in the form of a pixel-wise Gaussian Mixture Model (GMM). Other statistical models can be used, including running averages and medians, non-parametric models, and parametric models having different distributions. The GMM describes statistically the historical behavior of the pixels in the highlighted area; for each new incoming frame, the pixel values in the area are compared to their respective GMM and a determination is made as to whether their values correspond to the observed history. If they don't, which happens, for example, when a car traverses the detection area, a foreground detection signal is triggered. When a foreground detection signal is triggered for a large enough number of pixels, a vehicle detection signal is triggered. Morphological operations usually accompany pixel-wise decisions in order to filter out noises and to fill holes in detections. Note that in the case where the vehicle stops in the second ROI for a long enough period of time, pixel values associated with the vehicle will usually be absorbed into the background model, leading to false negatives of the vehicle detection. Foreground-aware background models can be used to avoid the vehicle being absorbed into the background model. One approach is described in the disclosure of co-pending and commonly assigned U.S. application Ser. No. 14/262,360, filed on Apr. 25, 2014 (Attorney Docket No. 20131356US01/XERZ203104US01) entitled “SYSTEMS AND METHODS FOR COMPUTER VISION BACKGROUND ESTIMATION USING FOREGROUND-AWARE STATISTICAL MODELS,” by, Qun Li, et al., the content of which is totally incorporated herein by reference. Alternative implementations of vehicle detection include motion detection algorithms that detect significant motion in the detection area. Motion detection is usually performed via temporal frame differencing and morphological filtering. In contrast to foreground detection, which also detects stationary foreground objects, motion detection only detects objects in motion at a speed determined by the frame rate of the video and the video acquisition geometry. In other embodiments, computer vision techniques for object recognition and localization can be used on still frames. These techniques typically entail a training stage where the appearance of multiple labeled sample objects in a given feature space (e.g., Harris Corners, SIFT, HOG, LBP, etc.) is fed to a classifier (e.g., support vector machine—SVM, neural network, decision tree, expectation-maximization—EM, k nearest neighbors—k-NN, other clustering algorithms, etc.) that is trained on the available feature representations of the labeled samples. The trained classifier is then applied to features extracted from image areas in the second ROI from frames of interest and outputs the parameters of bounding boxes (e.g., location, width and height) surrounding the matching candidates. In one embodiment, the classifier can be trained on features of vehicles or pedestrians (positive samples) as well as features of asphalt, grass, windows, floors, etc. (negative features). Upon operation of the trained classifier, a classification score on an image test area of interest is issued indicating a matching score of the test area relative to the positive samples. A high matching score would indicate detection of a vehicle. In one embodiment, the classification results can be used to verify order accuracy. In another embodiment, the classification results and timing information can be used to analyze or predict customer experience time relative to order type which may be inferred from the classification results. In yet another embodiment, classification results can be used to analyze general statistics including relationships between order type and time of day, weather conditions, time of year, vehicle type, vehicle occupancy, etc.

The object identification module 20 determines whether objects in the goods exchange ROI correspond to objects associated with a “goods received” event and issues a “goods received” event alert if so. The alert can include a real-time notification to a store manager or employee, an update to a database entry, an update to a performance statistic, or a real-time visual notification. This module may operate continuously (e.g., on every incoming frame) or only when required based on the outputs of the ROI motion detection and the vehicle detection modules. In one embodiment, the object identification module 20 is an image-based classifier that undergoes a training stage before operation. In the training stage, features extracted from manually labeled images of positive (e.g., hand out with bag or cup) and negative (e.g., asphalt, window, car) samples are fed to a machine learning classifier which learns the statistical differences between the features describing the appearance of the classes. In the operational stage, features are extracted from the ROI in each incoming frame (or as needed based on the output of modules 16 and 18) and fed to the trained classifier, which outputs a decision regarding the presence or absence of goods in the ROI. Given a detection of the presence of goods in the ROI, a “goods received” event alert will be issued by the object identification module.

In one embodiment, multiple occurrences of the detection of goods in a number of frames need to be detected before the issuance of an alert, in order to reduce false positives. Alternatively, voting schemes (e.g., based on majority vote across a sequence of adjacent frames on which detections took place) can be used to determine a decision. Single or multiple alerts for the detections of multiple types of goods can also be given for a single customer (for example, a beverage tray may be handed to the customer first, then a bag of food, etc.). Accordingly, it will be appreciated that multiple goods-received events can occur for a single customer as an order is filled. The multiple events can be considered individually or collectively depending on the particular application.

In one embodiment, color features are used (specifically, three dimensional histograms of color), but other features may be used in an implementation, including histograms of gradients (HOG), local binary patterns (LBP), maximally stable extremal regions (MSER), features resulting from the scale-invariant feature transform (SIFT), speeded-up robust features (SURF), among others. Examples of machine learning classifiers include neural networks, support vector machines (SVM), decision trees, bagged decision trees (also known as tree baggers or ensembles of trees), and clustering methods. In an actual system, a temporal filter may be used before detections of goods are reported. For example, the system may require multiple detections of an object before a final decision about the “goods received” event is given, or require the presence of a car or motion as described in the optional modules 16 and 18. Since object detection is performed, fine-grained classification of the goods exchanged can be performed. Specifically, in addition to enabling detection of a goods exchange event, aspects of the present disclosure are capable of determining the type of goods that are exchanged. In this case, a temporal filter could also be used before classifications of goods are reported.

In one embodiment, multiple two-class classifiers are trained for each class. In other words, each classifier is a one-versus-the-rest two-class classifier. Each classifier is then applied to the goods received ROI and the decision of each classifier is fused to produce a final decision. Compared to a multi-class classifier, an ensemble of two-class classifiers typically yields higher classification accuracy. Specifically, if N different object classes are to be detected, then N different two-class classifiers are trained. Each classifier is assigned an object class and fed positive samples from features extracted from images of that object; for that classifier, negative samples include features extracted from images of the remaining N−1 object classes and background that does not contain any of the N objects of interest or that contains other objects excluding the N objects.

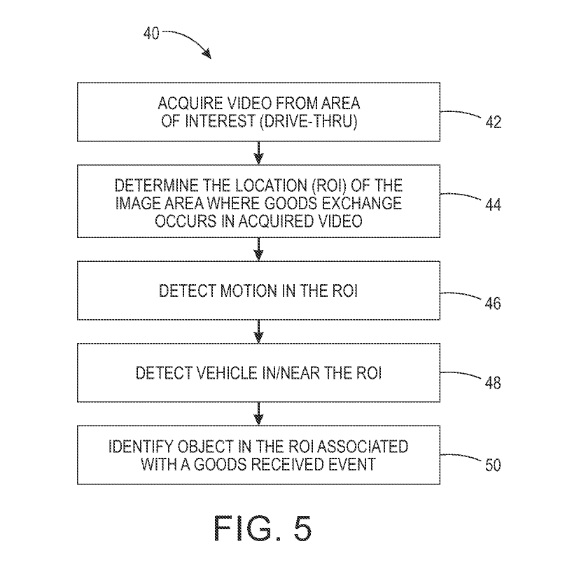

Turning to FIG. 5, an exemplary method 40 in accordance with the present disclosure generally includes acquiring video images of a location including an area of interest, such as a drive-thru window in process step 42. In process step 44, the first ROI is assigned. As noted, the assignment of the ROI will typically be done manually since, once assigned, the ROI generally remains the same unless the camera is moved. However, automated assignment or determination of the ROI can also be performed. Optional process steps 46 and 48 include detecting motion in the ROI, and/or detecting a vehicle in a second ROI that is adjacent to, partially overlapping with, or the same as the first ROI. As noted, these are optional and serve to increase the computational efficiency of the method. In process step 50, an object associated with a goods received event is detected.

The performance of the exemplary method relative to goods classification accuracy from color features of manually extracted frames was tested on three classes of goods, namely ‘bags’, ‘coffee cups’ and ‘soft drink cups’. For each class, a one vs. rest classifier was trained: four different binary classifiers were trained in total, one for each goods class, and one for the ‘no goods’ class. Four types of classifiers were used: nearest neighbor, SVM, a decision-tree based, and an ensemble of decision trees. 60% of the data was used to train the classifier (training data) and 40% of the data was used to test the performance of the classifier (test data). This procedure was repeated five times (each time the samples comprising training and test data sets were randomly selected) and the accuracy results were averaged.

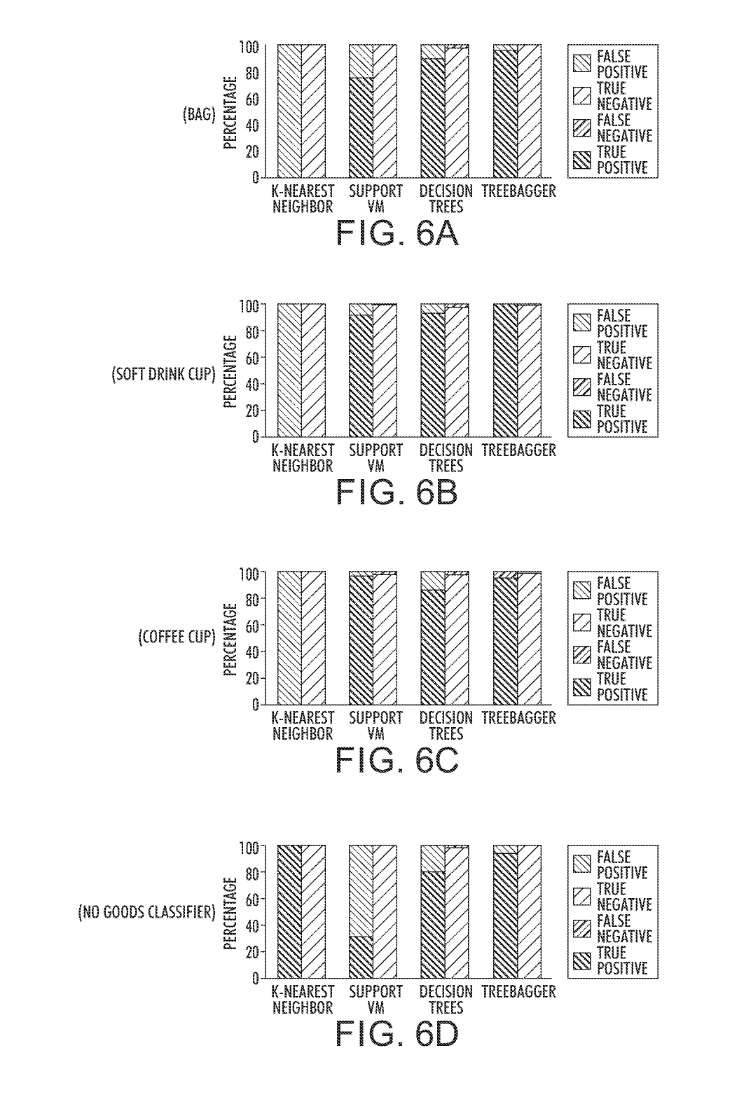

FIGS. 6A-6D include the performance of the classifiers on the four classes, where the height of each colored bar is proportional to a performance attribute, namely: true positives, false positives, true negatives and false negatives, as labeled. It will be appreciated that the cross-hatching associated with each labeled performance attribute is consistent throughout FIG. 6A-6D. While other features were tested (namely LBPs and color+LBPs), it was found that the performance of the classifiers was generally best with color features. It can be seen that the ensemble of decision trees outperforms the rest of the classifiers on all classes tested. Also, a collection of binary classifiers will work most of the time since the exchange of goods usually occurs with one object at a time. In order to support handoff of multiple objects, binary classifiers for all object combinations can be utilized.

There is no limitation made herein to the type of business or the subject (such as customers and/or vehicles) being monitored in the area of interest or the object (such as goods, documents etc.). The embodiments contemplated herein are amenable to any application where subjects can wait in queues to reach a goods/service point. Non-limiting examples, for illustrative purposes only, include banks (indoor and drive-thru teller lanes), grocery and retail stores (check-out lanes), airports (security check points, ticketing kiosks, boarding areas and platforms), road routes (i.e., construction, detours, etc.), restaurants (such as fast food counters and drive-thrus), theaters, and the like.

Although the method is illustrated and described above in the form of a series of acts or events, it will be appreciated that the various methods or processes of the present disclosure are not limited by the illustrated ordering of such acts or events. In this regard, except as specifically provided hereinafter, some acts or events may occur in different order and/or concurrently with other acts or events apart from those illustrated and described herein in accordance with the disclosure. It is further noted that not all illustrated steps may be required to implement a process or method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated system, wherein the disclosure is not limited to the specific applications and embodiments illustrated and described herein.

A primary application is notification of “goods received” event as they happen (real-time). Accordingly, such a system and method utilizes real-time processing where alerts can be given within seconds of the event. An alternative approach implements a post-operation review, where an analyst or store manager can review information at a later time to understand store performance. A post operation review would not utilize real-time processing and could be performed on the video data at a later time or at a different place as desired.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for detection of a goods-received event comprising:
acquiring images of a vehicular drive-thru associated with a business;
determining a first region of interest within the images, the region of interest including at least a portion of a region in which goods are delivered to a customer; and
analyzing the images using at least one computer vision technique to determine when goods are received by a customer;
wherein the analyzing includes identifying at least one item belonging to a class of items, the at least one item's presence in the region of interest being indicative of a goods-received event.

2. The method of claim 1, further comprising, prior to the analyzing, detecting motion within the region of interest, and analyzing the images only after motion is detected.

3. The method of claim 1, further comprising, prior to the analyzing, detecting a vehicle within a second region of interest.

4. The method of claim 3, wherein the analyzing is only performed when a vehicle is detected in the second region of interest.

5. The method of claim 1, further comprising issuing a goods-received alert when goods are received by the customer.

6. The method of claim 5, wherein the alert includes at least one of a real-time notification to a store manager or employee, an update to a database entry, an update to a performance statistic, or a real-time visual notification.

7. The method of claim 1, wherein the analyzing includes using an image-based classifier to detect at least one specific item within the region of interest.

8. The method of claim 7, wherein an output of the image-based classifier is compared to a customer order list to verify order accuracy.

9. The method of claim 7, wherein an output of the image-based classifier and timing information are used to analyze a customer experience time relative to order type.

10. The method of claim 7, wherein an output of the image-based classifier is used to analyze general statistics including relationships between order type and time of day, weather conditions, time of year, vehicle type, vehicle occupancy, etc.

11. The method of claim 7, wherein the using an image-based classifier includes using at least one of a neural network, a support vector machine (SVM), a decision tree, a decision tree ensemble, or a clustering method.

12. The method of claim 1, wherein the analyzing includes training multiple two-class classifiers for each class of items.

13. A system for video-based detection of a goods received event, the system comprising a device for monitoring customers including a memory in communication with a processor configured to:
acquire images of a vehicular drive-thru associated with a business;
determine a first region of interest within the images, the region of interest including at least a portion of a region in which goods are delivered to a customer; and
analyze the images using at least one computer vision technique to determine when goods are received by a customer, the analyzing includes identifying at least one item belonging to a class of items, the at least one item's presence in the region of interest being indicative of a goods-received event.

14. The system of claim 13, wherein the processor is further configured to, prior to analyzing the images to determine when goods are received by a customer, detect motion within the region of interest.

15. The system of claim 14, wherein the processor is further configured to analyze the images to determine when goods are received by a customer only after motion is detected.

16. The system of claim 13, wherein the processor is further configured to, prior to analyzing the images to determine when goods are received by a customer, detect a vehicle within a second region of interest.

17. The system of claim 16, wherein the processor is further configured to analyze the images to determine when goods are received by a customer only after a vehicle is detected.

18. The system of claim 16 wherein the second region of interest is one of adjacent to, partially overlapping with, and the same as the first region of interest.

19. The system of claim 13, wherein the processor is further configured to analyze the images to determine when goods are received by a customer using an image-based classifier to detect specific items within the region of interest.

20. The system of claim 19, wherein the processor is further configured to use an image-based classifier including at least one of a neural network, a support vector machine (SVM), a decision tree, bagged decision trees, or a clustering method.

21. The system of claim 19, wherein the processor is further configured to compare an output of the image-based classifier to a customer order list to verify order accuracy.

22. The system of claim 19, wherein the processor is further configured to analyze a customer experience time relative to order type using an output of the image-based classifier and timing information.

23. The system of claim 19, wherein the processor is further configured to analyze at least one general statistic using an output of the image-based classifier, the at least one general statistic including a relationship between order type and one or more of time of day, weather conditions, time of year, vehicle type, or vehicle occupancy.

24. The system of claim 13, wherein the processor is further configured to train multiple two-class classifiers for each class of items.
